(19) United States
(12) Patent Application Publication
(10) Pub. No.: US 2010/0320892 A1
(43) Pub. Date: Dec. 23, 2010

(54) HEAT DISSIPATION ENHANCED LED LAMP FOR SPOTLIGHT

(76) Inventor: Chih-Ming YU, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/706,935

(22) Filed: Feb. 17, 2010

Related U.S. Application Data
(63) Continuation-in-part of application No. 12/457,718, filed on Jun. 19, 2009.

(51) Int. Cl. H01J 61/52

(52) U.S. Cl. 313/46

(57) ABSTRACT

In a LED lamp, a thermally conductive electric insulator is filled in a cavity of a lamp base, a LED filament includes an AC LED device, a resistor is connected with the AC LED device in series between two electrodes of the lamp base to form an electric loop, and a reflective cup has a hole at a bottom thereof to expose the AC LED device and a reflective surface to reflect light of the AC LED device for providing a spotlight. The thermally conductive electric insulator mechanically contacts the LED filament and the first one of the two electrodes, and thereby establishes a heat dissipation channel from the AC LED device to the first electrode therethrough.

### CROSS REFERENCE TO RELATED APPLICATION

This application is a continuation-in-part of U.S. patent application Sera No. 12/457,718, filed Jun. 19, 2009 and entitled “Heat Dissipation Enhanced LED Lamp,” the disclosure of which is hereby incorporated by reference as if set forth fully herein.

### FIELD OF THE INVENTION

The present invention is related generally to electric lamps and, more particularly, to a LED lamp for spotlight.

### BACKGROUND OF THE INVENTION

Light bulbs can be classified into illumination lamps and decoration lamps according to their applications. The spotlight bulb is one of decoration lamps. Different from the wide-range and uniform light irradiation provided by an illumination lamp, a lamp for spotlight simply focuses its light within a narrow area. Currently, most of lamps for spotlight use halogen bulbs. Although halogen bulbs have advantages of low price, high luminance and soft color temperature, they also have defects such as high power consumption, high temperature, and short service life. The application of light emitting diodes (LEDs) to light bulbs introduces smaller power consumption and longer service life than conventional light bulbs, but is still hard for commercialization.

A LED lamp using a direct-current (DC) LED device as the filament must be equipped with a power converter for converting the alternating-current (AC) power voltage into a DC input voltage for the DC LED device. The power converter not only requires additional component cost for the LED lamp, but also cannot fit entirely into the standard lamp bases of ordinary light bulbs. For a LED lamp to be equipped with a power converter, it is necessary to develop special molds to produce containers and corresponding mechanism different from those of ordinary light bulbs to fit the power converter therewithin, which nevertheless increases the cost and volume of the LED lamp. On the other hand, a DC LED device generates heat when it is powered on and therefore, an additional heat dissipation mechanism is required to handle the heat. If the heat is not effectively dissipated, the resulting high temperature will reduce the emissive efficiency and service life of the DC LED device and produce other adverse effects such as wavelength shift. Moreover, the power converter, particularly the inductor and integrated circuit therein, also generates heat during power conversion, and the consequent high temperature may damage the inductor and integrated circuit and cause failure of the LED lamp accordingly. The problems caused by insufficient heat dissipation are aggravated especially in high power applications, such as in lighting fixtures for illumination purposes, where the DC LED device generates relatively more heat. To adapt to the relatively small space within ordinary lamp bases, some LED lamps use a plurality of low power lamp type LED devices in conjunction with a simple bridge rectifier circuit. However, low power LED devices are poorly accepted in the market due to their generally low brightness, and these LED lamps tend to have serious light attenuation problems as a result of poor heat dissipation.

In recent years, AC LED devices are maturing technically, have improved in brightness, and therefore have had commercial value. An AC LED device includes a plurality of serially and/or parallel connected LED electronic elements manufactured on an epitaxial chip. The epitaxial chip is packaged and then connected in series with a resistor having a particular resistance so as to withstand high voltage, e.g., 110 V or 220 V, mains electricity, thus dispensing with the power converter or rectifier circuit required for a DC LED device. In consequence, the cost of an AC LED lamp is lowered in comparison with its DC counterpart, and the circuit related quality issues reduced. An AC LED device, though conveniently applicable in small spaces, still demands heat dissipation. This is especially true in high power applications, such as lighting fixtures for illumination purposes, where the AC LED device generates relatively more heat. If a heat dissipating device is added, the resultant LED lamp will be bulky and costly. However, if no additional assistance is provided to enhance heat dissipation from the AC LED device, the emissive efficiency and service life of the AC LED device will be reduced, wavelength shift is likely to happen, and even worse, the LED epitaxial chip may be burned out.

For clearer illustration, a commercial LED lamp for spotlight is shown in FIG. 11. In order to enhance the heat dissipation of LED devices 102, a huge heat sink 104 is added outside a reflective cup 106, and the LED devices 102 are installed on a highly thermally conductive holder 108 that is bounded to the heat sink 104. Therefore, a good heat dissipation channel is established from the LED devices 102 to the heat sink 104 through the holder 108. Unavoidably, as the volume of the heat sink 104 is usually several times larger than that of the lamp base 110, the volume of this LED lamp 100 is much greater than a conventional spotlight bulb. In addition, the heat sink 104 makes the lamp structure more complex, so that not only mechanism for bonding the heat sink 104 to the lamp base 110 are needed, but also the assembly of the LED lamp 100 becomes more difficult. Furthermore, in order to match the reflective cups 106 having different apertures or shapes in different applications, the shape and size of the heat sink 104 need to change accordingly, thus increasing the cost and difficulty in production management.

### SUMMARY OF THE INVENTION

An object of the present invention is to provide a LED lamp for spotlight.

Another object of the present invention is directed to a high power application of LED devices.

In a LED lamp for spotlight according to the present invention, a lamp base has two electrodes and a cavity, a LED filament includes an AC LED device of a rated power ranging from 0.3 to 5 W, a resistor of a resistance ranging from 50 to 50,000Ω is electrically connected with the AC LED device in series between the two electrodes to form an electric loop, a thermally conductive electric insulator of a thermal conductivity ranging from 0.25 to 30 W/mK is filled in the cavity and mechanically contacts with the LED filament and one of the two electrodes to thereby establish a heat dissipation channel from the LED filament to this electrode through the thermally conductive electric insulator, and a reflective cup has a hole at a bottom thereof to expose the AC LED device and a reflective surface at an inner surface thereof to reflect light of the AC LED device.

### BRIEF DESCRIPTION OF THE DRAWINGS

These and other objects, features and advantages of the present invention will become apparent to those skilled in the art upon consideration of the following description of the preferred embodiments according to the present invention taken in conjunction with the accompanying drawings, in which:

FIG. 1 is a cross-sectional view of a first embodiment according to the present invention;

FIG. 2 shows an equivalent circuit of the LED lamp depicted in FIG. 1;

FIG. 3 provides three AC LED epitaxial chips;

FIG. 4 is a top view of a LED filament using multiple LED epitaxial chips;

FIG. 5 is a cross-sectional view of a second embodiment according to the present invention;

FIG. 6 is a three-dimensional view of the reflective cup shown in FIG. 5;

FIG. 7 is a side view of the LED lamp shown in FIG. 5;

FIG. 8 is a cross-sectional view of a third embodiment according to the present invention;

FIG. 9 is a cross-sectional view of a fourth embodiment according to the present invention;

FIG. 10 is a cross-sectional view of a fifth embodiment according to the present invention; and

FIG. 11 is a three-dimensional view of a conventional LED lamp for spotlight.

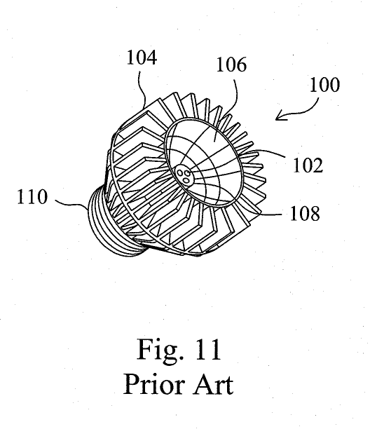

### DETAILED DESCRIPTION OF THE INVENTION

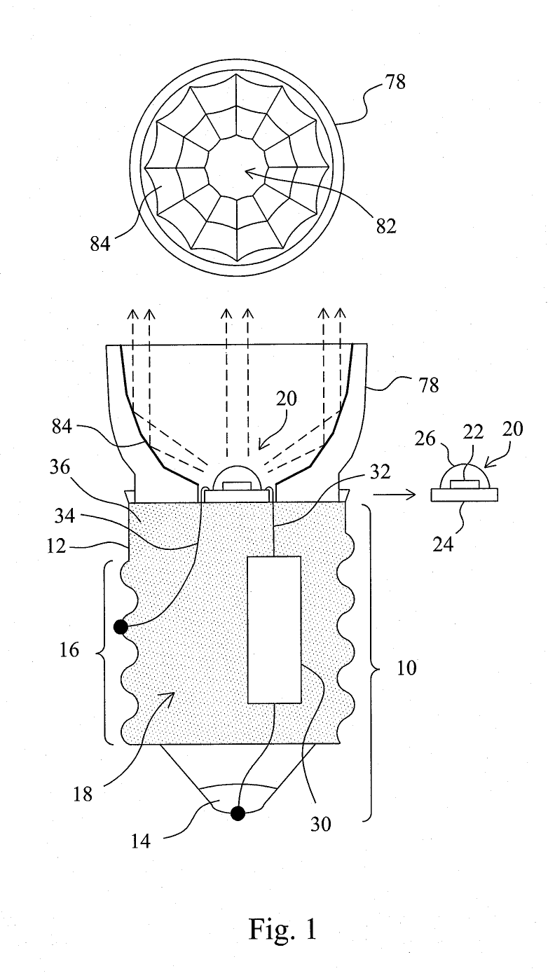

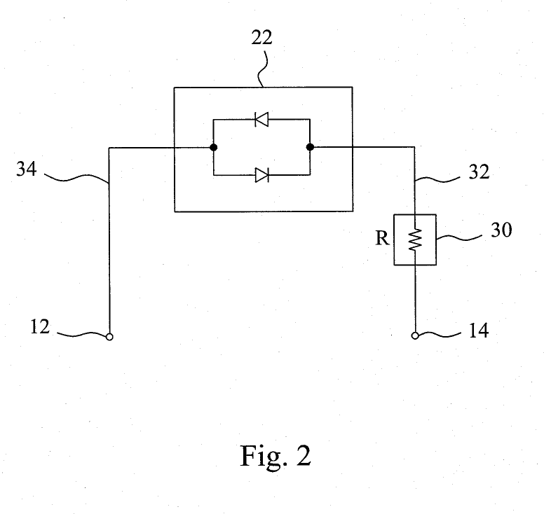

FIG. 1 is a cross-sectional view of a first embodiment according to the present invention, in which a standard lamp base 10 for use with a small light bulb is used to accentuate the features of heat dissipation enhancement according to the present invention. The lamp base 10 has two electrodes 12 and 14 for receiving an AC power source. As would be understood by a person of ordinary skill in the art, the electrode 12 is a metal housing which has a spiral-threaded configuration 16 and a cavity 18 therein. In this LED lamp, an AC LED device 20 is used as the filament which includes an AC LED epitaxial chip 22 bounded on a leadframe 24 and covered with an encapsulant 26. As the LED packaging is well-known, the package structure of the AC LED device 20 is not detailed in the drawing for the sake of simplicity. A resistor 30 has one end soldered to the electrode 14 and the opposite end connected to a wire 32 that is soldered to the AC LED device 20. Another wire 34 has its two ends soldered to the electrode 12 and the AC LED device 20, respectively. This LED lamp has the equivalent circuit shown in FIG. 2, in which the AC LED epitaxial chip 22 and the resistor 30 are connected in series between the electrodes 12 and 14. As would be understood by a person of ordinary skill in the art, a so-called AC LED epitaxial chip includes LED electronic elements oriented in two opposite directions and connected in parallel between two pins, with at least one LED electronic element in each direction. The LED electronic elements oriented in the two opposite directions are lit during the positive and negative half cycles of the AC power source, respectively. The resistor 30 has a resistance R chosen according to the current intensity required by design. The resistor 30 also serves to protect the AC LED epitaxial chip 22. More specifically, when a surge occurs in the AC power source applied to the electrodes 12 and 14, the resistor 30 will absorb most of the surge voltage. Referring back to FIG. 1, a major feature of the present invention is to fill the cavity 18 with a thermally conductive electric insulator 36 such that the thermally conductive electric insulator 36 is in mechanical contact with the electrode 12 and the LED filament, i.e. the leadframe 24 in this embodiment, to provide a thermal channel to transfer the heat generated by the AC LED epitaxial chip 22 to the electrode 12 when the AC LED epitaxial chip 22 is powered on to emit light, thereby enhancing the heat dissipation therefrom. As would be understood by a person of ordinary skill in the art, the leadframe 24 typically includes a metal plate for facilitating heat dissipation from the AC LED epitaxial chip 22. Therefore, by attaching the leadframe 24 to the thermally conductive electric insulator 36, good thermal conduction effect can be achieved. Alternatively, the LED filament may include a circuit board to be bounded with the AC LED epitaxial chip 22 thereon. In this case, the circuit board is attached on the thermally conductive electric insulator 36, and the AC LED epitaxial chip 22 may be a surface mounting device (SMD) or have a chip on board (COB) package structure, in addition to the lamp type LED device 22 shown in FIG. 1. The thermally conductive electric insulator 36 also assists in heat dissipation from the resistor 30 because the resistor 30 is buried therein. A reflective cup 78 is fixed on the thermally conductive electric insulator 36 by glue or other bounding mechanism. As shown by a top view of the reflective cup 78 in the upper of FIG. 1, the reflective cup 78 has a hole 82 at its bottom to expose the AC LED device 20 and a reflective surface 84 on its inner surface to reflect light of the AC LED device 20, and therefore, this LED lamp may provide a spotlight as designated by the dash arrows shown in FIG. 1.

For the thermally conductive electric insulator 36, it may select epoxy resin, or thermal conductor powder such as aluminum oxide, aluminum nitride, boron nitride, and any other thermally conductive material in powder form, or a mixture of epoxy resin and thermal conductor powder. Table 1 shows experiment results of using three different thermally conductive materials in the LED lamp of FIG. 1.

TABLE 1

| Thermally | | Power | | Condition after |
|---|---|---|---|---|
| conductive | Voltage of | consumed | Output | being lit |
| electric | AC power | by AC LED | brightness | continuously for |
| insulator 36 | source | device 20 | (lm) | 1,000 hours |
| Epoxy resin | 110 V | 1 | 65 | No abnormality |
| | | | | detected, |
| | | | | except for |
| | | | | relatively high |
| | | | | temperature |
| Epoxy resin + | 110 V | 1 | 68 | No abnormality |
| aluminum | | | | detected |
| oxide powder | | | | |
| Aluminum | 110 V | 1 | 68 | No abnormality |
| oxide powder | | | | detected |

As shown in Table 1, when epoxy resin, which has a lower thermal conductivity, was used as the thermally conductive electric insulator 36, a higher temperature was detected after the LED lamp was powered on. On the other hand, the mixture of epoxy resin and thermal conductor powder has a higher thermal conductivity, and therefore no abnormality was found during the lighting test. Good thermal conduction effect was also obtained by directly using thermal conductor powder, filled into the cavity 18 and compacted, as the thermally conductive electric insulator 36. In general, the LED lamp under test had satisfactory output brightness, and substantially no abnormality was detected after the LED lamp was lit continuously for 1,000 hours. In stead, other materials having suitable thermal conductivity may also be used as the thermally conductive electric insulator 36.

As shown in FIG. 1, the LED lamp has approximately the same size as the lamp base 10, possesses good heat dissipation ability, and is capable of high power applications that are unachievable by the prior art devices. Ordinary light bulbs are equipped with standard lamp bases. For example, lamp bases under the standards E12, E14, E17, E26 and E27 are for the ordinary tungsten light bulbs, and MR16 and GU10 lamp bases are for the ordinary halogen light bulbs. The lamp base of an ordinary halogen light bulb has an electrode formed as a columnar metal housing and separated from the other electrode by an electric insulator. Some other standard lamp bases use two needle-like electrodes that are insulated from each other. The lamp base for a LED lamp according to the present invention can be one of ordinary tungsten or halogen light bulbs or other standard lamp bases where there is always a cavity to be filled with the thermally conductive electric insulator 36, and in consequence at least one electrode of the lamp base serves to facilitate heat dissipation from the LED filament of the LED lamp. As the electrodes of standard lamp bases are exposed outside, good heat dissipation effect is attainable.

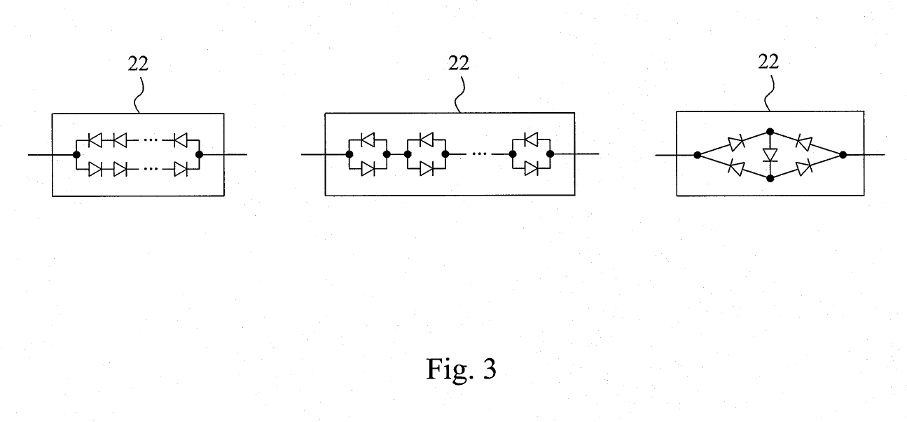

An AC LED epitaxial chip including more than two LEDs may be used for the AC LED epitaxial chip 22 to provide brighter illumination. FIG. 3 provides three such AC LED epitaxial chips 22. The first one in the left includes two LED strings parallel connected in opposite directions between two pins of the AC LED epitaxial chips 22, each LED string having two or more LEDs. The second case in the middle includes two or more pairs of LEDs serially connected between two pins of the AC LED epitaxial chips 22, each pair of LEDs parallel connected in opposite directions to each other. The last case in the right includes five or more LEDs having a bridge configuration between two pins of the AC LED epitaxial chips 22. There have been commercial products can be selected for these cases.

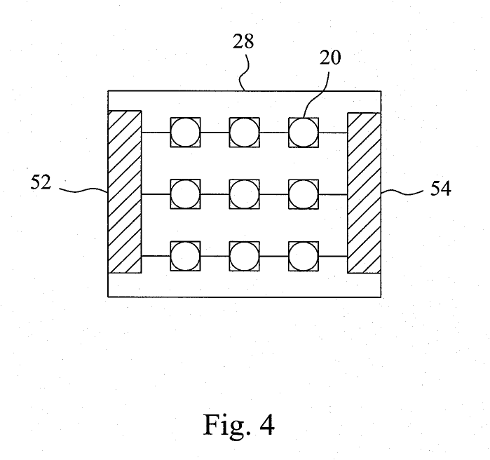

If it is desired to increase the brightness of a LED lamp, more AC LED devices 20 can be connected in series, in parallel, or in series and parallel in the LED filament. For example, as shown in FIG. 4, a LED filament includes nine AC LED devices 20 bounded on a circuit board 28 in such a manner that three rows of AC LED devices 20 are connected in parallel between solder pads 52 and 54 on the circuit board 28, and each row includes three AC LED devices 20. If each of the AC LED devices 20 operates at a power of 1 W, the LED filament shown in FIG. 4 can operate at a power as high as 9 W.

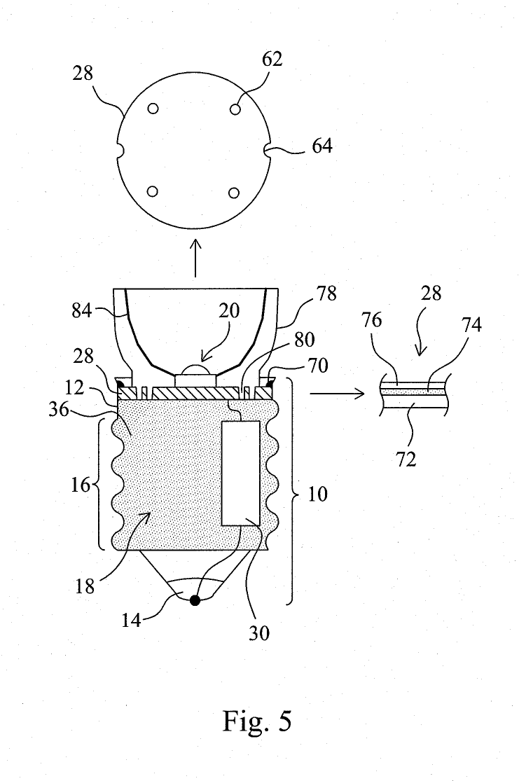

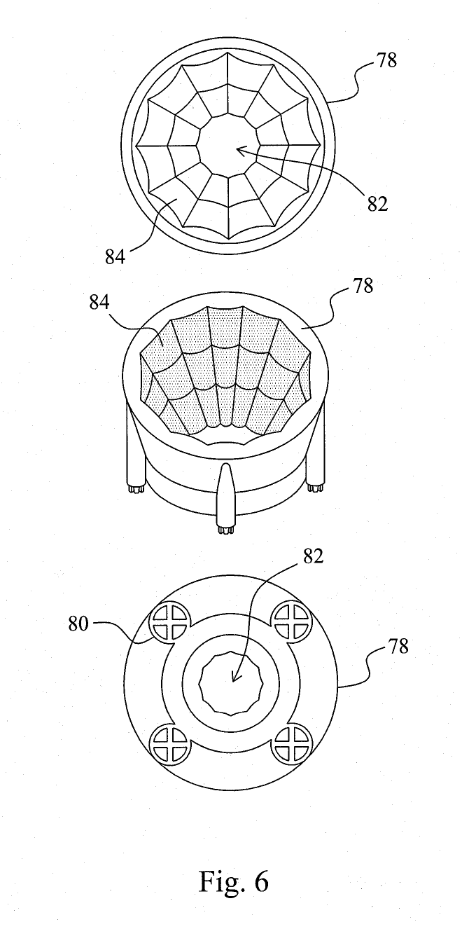

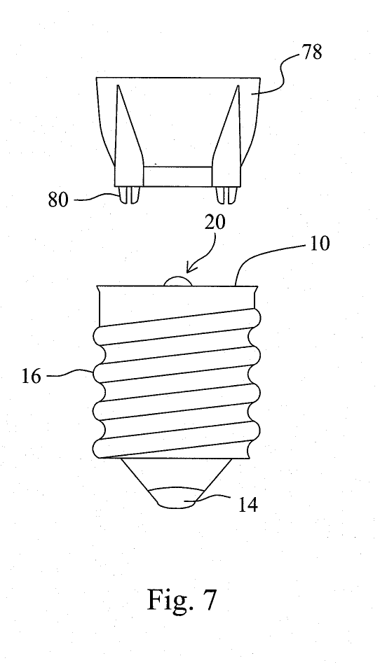

FIG. 5 is a cross-sectional view of a second embodiment according to the present invention, and FIG. 7 is a side view of this LED lamp. In this embodiment, the LED filament includes an AC LED device 20 mounted on a circuit board 28. As shown in the upper of FIG. 5, the circuit board 28 has through holes 64 to be soldered to the electrode 12 of the lamp base 10 by means of solder 70. A resistor 30 is connected between the circuit board 28 and the electrode 14 of the lamp base 10 and as a result, the AC LED device 20 and the resistor 30 are serially connected between the electrodes 12 and 14 to form an electric loop. A thermally conductive electric insulator 36 is filled in the cavity 18 of the lamp base 10 and mechanically contacts the circuit board 28 and the electrode 12, to establish a heat dissipation channel from the AC LED device 20 to the electrode 12 through the thermally conductive electric insulator 36. As shown in the right of FIG. 5, the circuit board 28 has an aluminum metal layer 72, a copper metal layer 76, and a thermally conductive layer 74 sandwiched therebetween, and this structure exhibits better heat dissipation capability than a glass fiber reinforced substrate. A reflective cup 78 is fixed on the circuit board 28. FIG. 6 provides a three-dimensional view, a top view, and a bottom view of the reflective cup 78, in which the reflective cup 78 is formed by coating a highly reflective film or plating a highly reflective metal such as aluminum or aluminum alloy on the inner surface of a plastic cup to be the reflective surface 84. Alternatively, the reflective cup 78 may be a metal cup having the reflective surface 84. The reflective cup 78 has elastic pins 80 protruding from its bottom, and as shown in the upper of FIG. 5, the circuit board 28 has holes 62 for the elastic pins 80 to plug in, so as to fix the reflective cup 78. In this embodiment, the reflective cup 78 is detachable from the circuit board 28. In other embodiments, the reflective cup 78 may be glued to the circuit board 28, clamped on the circuit board 28, or fixed on the circuit board 28 by other mechanisms. As the same as the first embodiment, the reflective cup 78 has a hole 82 at its bottom to expose the AC LED device 20 and a reflective surface 84 on its inner surface to reflect light of the AC LED device 20, and therefore, this LED lamp may provide a spotlight.

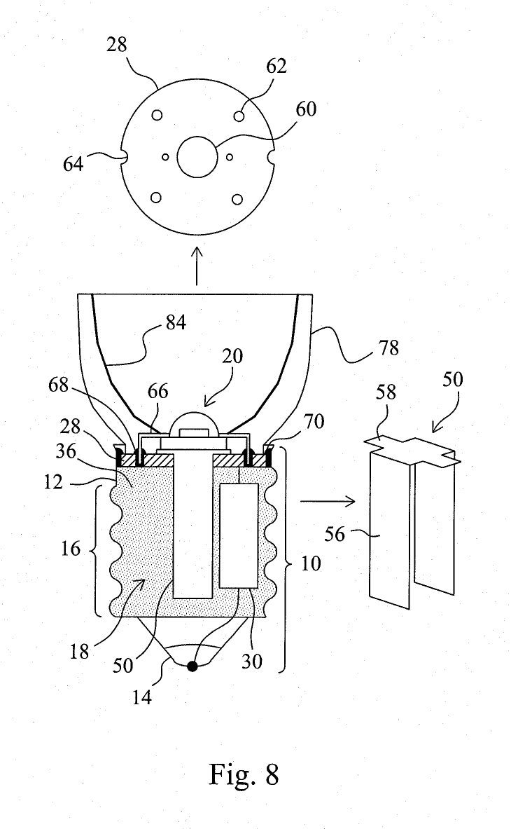

FIG. 8 is a cross-sectional view of a third embodiment according to the present invention, in which the LED filament includes an AC LED device 20 having a plastic leaded chip carrier (PLCC) package structure, a circuit board 28 for the AC LED device 20 to mount thereon by pins 66 and solders 68, and a thermally conductive member 50 having its upper end bounded with the AC LED device 20. As shown in the upper of FIG. 8, the circuit board 28 has a through hole 60 for the thermally conductive member 50 to pass therethrough, and the thermally conductive member 50 has its upper end above the circuit board 28 and its lower end buried in a thermally conductive electric insulator 36 filled in the cavity 18 of a lamp base 10. As shown in the right of FIG. 8, the thermally conductive member 50 has two strips 56 and two flanges 58, each of the strips 56 has an axial length ranging from 0.1 to 10 cm, preferably ranging from 0.5 to 3.0 cm, and the flanges 58 are sandwiched between the AC LED device 20 and the circuit board 28. The circuit board 28 has a glass fiber reinforced substrate or a metal substrate. Preferably, the circuit board 28 is also in mechanical contact with the thermally conductive electric insulator 36. As the same as in the second embodiment shown in FIG. 5, the circuit board 28 is soldered to an electrode 12 of the lamp base 10 by solder 70 through holes 64, and a resistor 30 is soldered between an electrode 14 of the lamp base 10 and the circuit board 28, such that the resistor 30 and the AC LED device 20 are connected in series between the electrodes 12 and 14 of the lamp base 10. Similar to the second embodiment shown in FIG. 5, the circuit board 28 has holes 62 to fix a reflective cup 78 by elastic pins (not shown in FIG. 8). The structure of the reflective cup 78 is the same as that shown in FIG. 6.

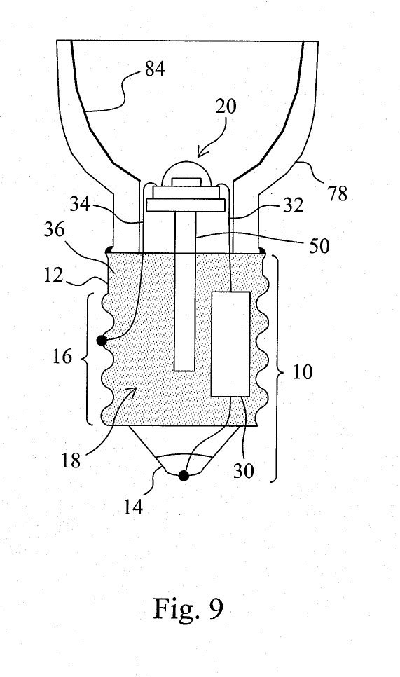

FIG. 9 is a cross-sectional view of a fourth embodiment according to the present invention, in which the LED filament includes an AC LED device 20 and a thermally conductive member 50 having a dish at its upper end for the AC LED device 20 to be bounded thereon. Preferably, the lower end of the thermally conductive member 50 has a rod or strip shape. The lower end of the thermally conductive member 50 is buried in a thermally conductive electric insulator 36 filled in the cavity 18 of a lamp base 10, so that the thermally conductive electric insulator 36 establishes a heat dissipation channel for the LED filament to an electrode 12 of the lamp base 10. The height of the AC LED device 20 can be adjusted by adjusting the length of the thermally conductive member 50 into the thermally conductive electric insulator 36. Wires 32 and 34 electrically connect the AC LED device 20 to a resistor 30 and the electrode 12 of the lamp base 10, and the resistor 30 is electrically connected to the electrode 14 of the lamp base 10, such that the AC LED device 20 and the resistor 30 are serially connected between the electrodes 12 and 14 of the lamp base 10. A reflective cup 78 is glued to or clamped on the upper end of the lamp base 10.

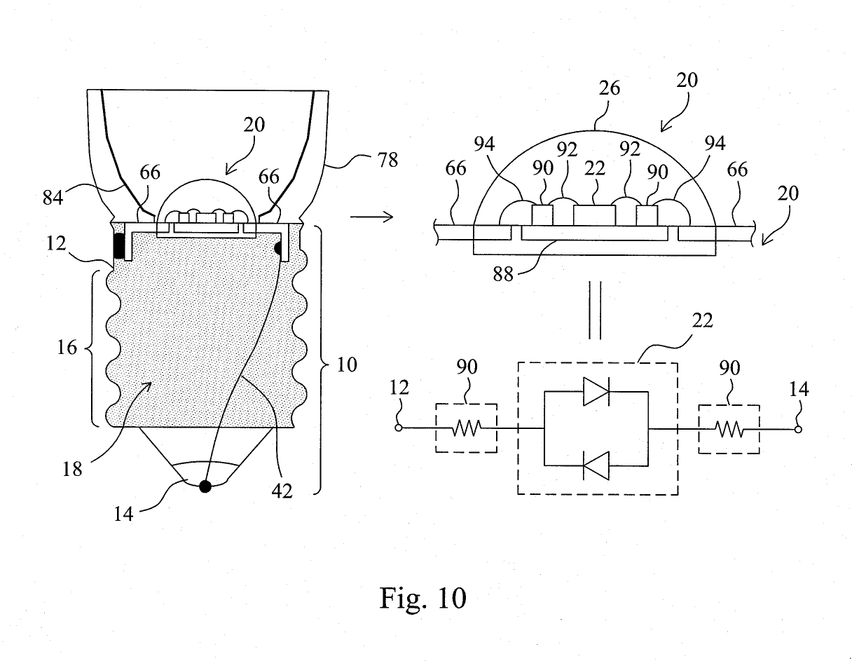

FIG. 10 is a cross-sectional view of a fifth embodiment according to the present invention, in which the LED filament includes an AC LED device 20, and the AC LED epitaxial chip 22 of the AC LED device 20 is packaged with chip resistors 90 in a same encapsulant 26. As shown in the right of FIG. 10, the AC LED epitaxial chip 22 and the chip resistors 90 are attached on a pad 88, and bounding wires 92 and 94 are used to electrically connect the AC LED epitaxial chip 22 to the chip resistors 90 and the chip resistors 90 to the pins 66, whose equivalent circuit is also shown in the drawing. The AC LED device 20 is attached on a thermally conductive electric insulator 36 filled in the cavity 18 of a lamp base 10, and has its pins 66 electrically connected to the electrodes 12 and 14 of the lamp base 10, respectively. In this embodiment, fewer components are used and thus simplify the assembly process of the LED lamp.

In the above embodiments, depending on practice applications, it is selected the AC LED device 20 having a rated power ranging from 0.3 to 5 W, preferably from 1 to 3 W, the thermally conductive electric insulator 36 having a thermal conductivity ranging from 0.25 to 30 W/mK, and the resistor 30 preferably having a resistance ranging from 50 to 50,000Ω. In addition, it is selected the AC LED device 20 having a rated input voltage ranging from 12 to 240 V. For a LED lamp using a single AC LED device 20, the rated input voltage of the AC LED device 20 is selected to be 110 or 220 V, depending on the power lines in its application. For a LED lamp using serially connected AC LED devices 20, the rated input voltage of each AC LED device 20 is selected to be smaller, for example 12 V. The reflective cup 78 may be fixed on the thermally conductive electric insulator 36, the circuit board 28 of the LED filament, or the lamp base 10, by gluing, clamping or other means.

Since the heat generated by the AC LED device 20 of the LED filament is transferred through the thermally conductive electric insulator 36 to the electrode 12 of the lamp base 10, where to dissipate heat to outside environment, no other heat sink is required, even in high power applications, such as for providing spotlight, and thus the reflective cup 78 may be designed with its aperture and shape according to demands, without requiring the other components to be changed accordingly, which also simplifies the management of mass production and spare parts. According to the present invention, as shown in FIG. 7, the LED lamp for spotlight has a very small volume, even smaller than a conventional spotlight bulb.

While the present invention has been described in conjunction with preferred embodiment thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A LED lamp comprising:
a LED filament including an AC LED device of a rated power ranging from 0.3 to 5 W;
a lamp base having two electrodes and a cavity, the first electrode having a spiral-threaded, columnar, or needle-like configuration;
a resistor of a resistance ranging from 50 to 50,000Ω, electrically connected with the AC LED device in series between the two electrodes to form an electric loop;
a thermally conductive electric insulator of a thermal conductivity ranging from 0.25 to 30 W/mK, filled in the cavity and mechanically contacting with the filament and the first electrode to thereby establish a heat dissipation channel from the AC LED device to the first electrode through the thermally conductive electric insulator; and
a reflective cup having a hole at a bottom thereof to expose the AC LED device and a reflective surface at an inner surface thereof to reflect light of the AC LED device, for producing a spotlight.

2. The LED lamp of claim 1, wherein the reflective cup is fixed on the lamp base or the thermally conductive electric insulator.

3. The LED lamp of claim 1, wherein the LED filament comprises a circuit board soldered to the first electrode and having the AC LED device bounded thereon.

4. The LED lamp of claim 3, wherein the reflective cup is fixed on the circuit board.

5. The LED lamp of claim 4, wherein the reflective cup is detachable from the circuit board.

6. The LED lamp of claim 4, wherein the reflective cup has one or more pins inserted in the circuit board.

7. The LED lamp of claim 4, wherein the reflective cup is glued to or clamped on the circuit board.

8. The LED lamp of claim 1, wherein the reflective cup comprises:
a plastic cup; and
a highly reflective film coated on a portion of the inner surface of the plastic cup.

9. The LED lamp of claim 1, wherein the reflective cup comprises a metal cup having the reflective surface.

10. The LED lamp of claim 1, wherein the AC LED device comprises an AC LED epitaxial chip packaged with the resistor in a same package.

11. The LED lamp of claim 1, wherein the thermally conductive electric insulator comprises an epoxy resin, thermal conductor powder, or a mixture thereof.

12. The LED lamp of claim 1, wherein the lamp base is one of the standard E12, E14, E17, E26, E27, MR16, and GU10 lamp bases.

13. The LED lamp of claim 1, wherein the rated power of the AC LED device ranges from 1 to 3 W.

14. The LED lamp of claim 3, wherein the LED filament comprises a thermally conductive member passing through the circuit board, and having a first end bounded with the AC LED device thereon and a second end buried in the thermally conductive electric insulator.

15. The LED lamp of claim 3, wherein the thermally conductive electric insulator directly contacts the circuit board.

16. The LED lamp of claim 1, wherein the LED filament comprises a thermally conductive member having a dish at a first end bounded with the AC LED device thereon and a second end buried in the thermally conductive electric insulator.

17. The LED lamp of claim 1, wherein the thermally conductive electric insulator directly contacts the AC LED.
